(19) United States
(12) Patent Application Publication
(10) Pub. No.: US 2008/0278347 A1
(43) Pub. Date: Nov. 13, 2008

(54) ELECTRONIC TOLL COLLECTION SYSTEM WITH MULTI-BEAM ANTENNAS

(76) Inventors: Thua Van Ho, Mississauga (CA); Wai-Cheung Tang, Mannheim (CA)

Correspondence Address: HANLEY, FLIGHT & ZIMMERMAN, LLC, 150 S. WACKER DRIVE, SUITE 2100, CHICAGO, IL, 60606, US

(21) Appl. No.: 12/117,902

(22) Filed: May 9, 2008

Related U.S. Application Data
(60) Provisional application No. 60/916,922, filed on May 9, 2007.

(51) Int. Cl. G08G 1/00

(52) U.S. Cl. 340/928

(57) ABSTRACT

An ETC system that uses lane-based phased array antennas to create both wide zone coverage areas upstream of the toll location and narrow zone coverage areas to complete transaction processing and vehicle location functions at the toll location. The phased array antennas are partly directed upstream with respect to the direction of travel in the roadway and they are each positioned to create a series of coverage areas generally parallel to the direction of travel and generally centered within a laneway.

### CROSS-REFERENCE TO RELATED APPLICATIONS

The present application claims priority to U.S. provisional patent application Ser. No. 60/916,922, filed May 9, 2007, the contents of which are hereby incorporated by reference.

### FIELD OF THE INVENTION

The present invention relates to electronic toll collection and, in particular, electronic toll collection systems and methods employing multi-beam antennas.

### BACKGROUND OF THE INVENTION

Electronic toll collection systems for conducting toll transactions with transponder-equipped vehicles are well known. Most existing ETC systems feature a locator or lane assignment function for determining the location of transponder-equipped vehicles within the roadway. This information together with information regarding successful ETC transactions is then used by an enforcement system to determine whether to take enforcement actions with regard to vehicles in the roadway. Those vehicles that traverse the toll area without conducting an ETC transaction may be subject to enforcement measures, such as photography, and may eventually be identified and fined.

One example of an ETC communications protocol used in existing ETC systems is a TDMA protocol. This type of ETC system typically requires a large wide area detection zone for initiating the ETC transaction well before the transponder reaches the final toll area. The tracking and lane assignment function is typically conducted using another separate set of antennas to detect transponder response signals throughout the wide area zone and to detect movement of the transponders through the zone using angle-of-arrival processing.

It would be advantageous to provide for an alternative ETC system.

### SUMMARY OF THE INVENTION

The present invention provides an ETC system that uses lane-based phased array antennas to create both wide zone coverage areas upstream of the toll location and narrow zone coverage areas to complete transaction processing and vehicle location functions at the toll location. The phased array antennas are partly directed upstream with respect to the direction of travel in the roadway and they are each positioned to create a series of coverage areas generally parallel to the direction of travel and generally centered within a laneway.

In one aspect, the present invention provides a electronic toll collection system for conducting electronic toll collection for a multilane roadway having a direction of travel. The system includes a first phased array antenna, a second phased array antenna and a reader. The first phased array antenna is disposed above a first laneway in the roadway and is positioned and configured to have a first plurality of beams, each beam having a beam center ray substantially within a first vertical plane parallel with the direction of travel. The second phased array antenna is disposed above a second laneway adjacent the first laneway in the roadway and is positioned and configured to have a second plurality of beams, each beam having a beam center ray substantially within a second vertical plane parallel with the direction of travel. The reader includes a first transceiver for exciting and controlling the first phased array antenna and for receiving incoming signals from the first phased array antenna, a second transceiver for exciting and controlling the second phased array antenna and for receiving incoming signals from the second phased array antenna, and a controller for controlling the transceivers. The controller is configured to conduct electronic toll communications with a transponder within the roadway through the antennas. The controller is configured to determine whether the transponder is located in the first laneway or the second laneway based on the incoming signals from the first and second phased array antennas.

In another aspect, the present invention provides a electronic toll collection system for conducting electronic toll collection for a multilane roadway having a direction of travel. The system includes a first phased array antenna, a second phased array antenna and a reader. The first phased array antenna is disposed above a first laneway in the roadway and is positioned and configured to have a first plurality of beams defining a first series of coverage areas substantially centered along a first beam path parallel to the direction of travel. The second phased array antenna is disposed above a second laneway adjacent the first laneway in the roadway and positioned and configured to have a second plurality of beams defining a second series of coverage areas substantially centered along a second beam path parallel to the direction of travel. The reader includes a first transceiver for exciting and controlling the first phased array antenna and for receiving incoming signals from the first phased array antenna, a second transceiver for exciting and controlling the second phased array antenna and for receiving incoming signals from the second phased array antenna, and a controller for controlling the transceivers. The controller is configured to conduct electronic toll communications with a transponder within the roadway through the antennas. The controller is configured to determine whether the transponder is located in the first laneway or the second laneway based on the incoming signals from the first and second phased array antennas.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show embodiments of the present invention, and in which:

FIG. 1 shows a perspective view of an embodiment of an electronic toll collection (ETC) system;

FIG. 2 shows, in block diagram form, an embodiment of the ETC system;

FIG. 3 diagrammatically shows a side view of the radiation pattern of one of the antennas in one embodiment;

FIG. 4 diagrammatically shows a plan view of the radiation pattern of the antennas in one embodiment;

FIG. 5 diagrammatically shows a plan view of the radiation pattern of an embodiment of a two antenna ETC system;

FIG. 6 diagrammatically shows an example of a scanning pattern for an embodiment of a four antenna ETC system; and

FIG. 7 diagrammatically shows another example of a scanning pattern for an embodiment of a four antenna ETC system.

Similar reference numerals are used in different figures to denote similar components.

### DESCRIPTION OF SPECIFIC EMBODIMENTS

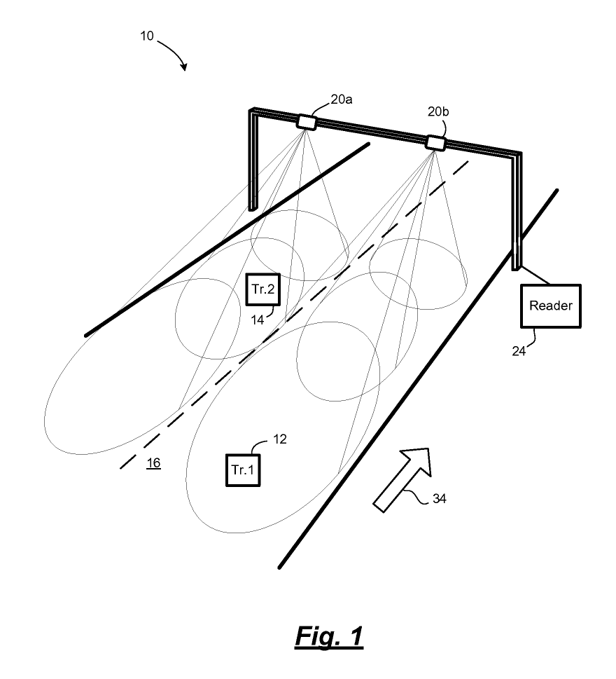

Reference is first made to FIG. 1, which shows a perspective view of an embodiment of an electronic toll collection system 10. The electronic toll collection system 10 may be employed to assess tolls for passing vehicles in a roadway 16, where the vehicles contain transponders for communicating with the electronic toll collection system 10. Example transponders 12, 14 are shown within the roadway 16.

The roadway 16 is a multilane roadway. In this example, the roadway 16 is shown as having two lanes but, in other example, it may have more lanes in other examples. The two lanes are for traffic traveling in the same direction, as indicated by arrow 32.

The electronic toll collection system 10 includes a roadside reader 24 connected to antennas 20 (shown individually as 20a and 20b). The antennas 20 are configured to have radiation patterns that define one or more communication zones within which the antennas 20 may exchange RF transmissions with transponders 12, 14. The radiation patterns and communication zones will be explained in greater detail below.

The reader 24 receives RF signals induced in the antennas 20 by transmissions from the transponders 12, 14, and it supplies excitation signals to the antennas 20 to propagate outgoing transmissions into the communication zones. Transmissions from the antennas 20 are time multiplexed to avoid interference. In other words, the electronic toll collection system 10 iteratively scans across the width of the roadway 16. The communications are typically structured and formatted in accordance with a predefined ETC communication protocol. Example protocols will be familiar to those ordinarily skilled in the art.

The electronic toll collection system 10 shown in FIG. 1 is an example of an open road ETC system, where communications between the system and transponders occur at highway speeds as vehicles pass through the communication zone. In the open road system, the vehicles may traverse the communication zone in any of the lanes in the roadway 16 and the toll transaction is conducted by the time the vehicle passes through the communication zone. Vehicles that are not equipped with transponders or vehicles for which the transaction is not completed are dealt with by way of an enforcement mechanism. Typically, the enforcement mechanism may include cameras positioned to photograph the vehicle, license plate and/or driver of any vehicles traversing the communication zone without paying the toll. Other enforcement mechanism may also be employed.

Other example systems may be “gated” or “closed-road” ETC systems. These types of systems usually have a toll plaza spanning the roadway 16, where individual lanes are separated by islands and, in some cases, toll booths, and where vehicles enter one of the individual lanes. In the individual lanes the toll payment is processed electronically or manually (through exchange of cash with a toll booth operator or automated tool booth), and a successful transaction is indicated by way of indicator lights, the raising of a gate, or other mechanisms. Enforcement mechanisms may also be employed in these types of ETC systems. For example, cameras may be used if a vehicle proceeds through the toll area despite not having received a successful transaction indication on the indicator lights.

It will be appreciated that it is desirable to identify the location of vehicles traversing the communication zones. One reason for identifying the location of a vehicle is to coordinate vehicle identity with enforcement mechanisms. For example if three vehicles pass through a communication zone and two of the vehicles successfully conduct a toll transaction it is necessary for the ETC system to know the locations of the three vehicles for the purpose of determining which vehicle should be subject to enforcement measures, such as photography. For this reason, ETC systems typically perform a “lane assignment” or locator function.

Some existing ETC systems, for example those used in open road installations, may use a pair of ‘detector’ antenna arrays situated on opposite sides of the roadway and scanning across the communication zone to listen for transponder response signals. The detector antenna arrays are in addition to the other antennas used by readers to actually conduct communications with the transponders and perform ETC transactions. The detector antenna arrays use angle of arrival (AOA) processing to determine the location of a given transponder based on the intersection of the particular beams for each antenna receiving the transponder response signal. In some embodiments, this determination may also take into account signal strength information and other factors. An example of a system having detector antenna arrays is described in detail in U.S. Pat. No. 6,025,799 to Ho et al., the contents of which are hereby incorporated by reference. This type of ETC locator system may typically be used in connection with an ETC system operating using a TDMA protocol.

Some other existing ETC systems may not employ separate locator antennas, but instead count the number of transponder response signals received by each antenna in a set of antennas spanning the roadway 16 and determine the vehicle location using a voting algorithm. This type of system requires short tightly defined communication zones for each antenna so that responses received by the antenna may be associated with a certain lane. Such a system is described, by way of example, in U.S. Pat. No. 6,219,613, to Terrier et al., the contents of which are hereby incorporated by reference. This type of system may typically be used in connection with an ETC system operating using the proprietary IAG (Northeastern Inter-Agency Group) protocol for ETC communications.

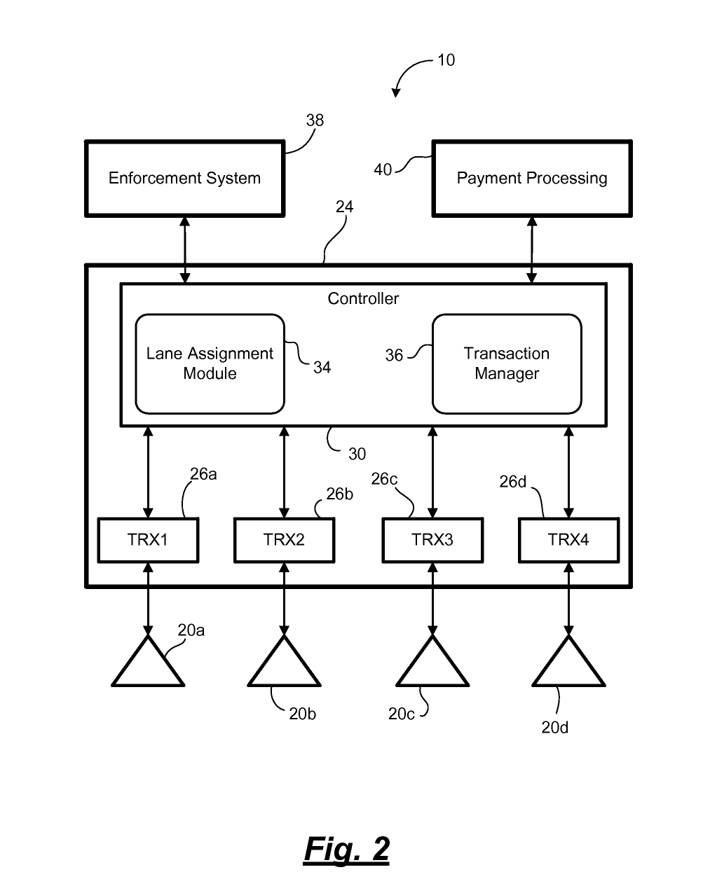

Reference is now also made to FIG. 2, which shows, in block diagram form, an embodiment of the ETC system 10. As shown, in this embodiment, the ETC system 10 includes four antennas 20a, 20b, 20c, and 20d (collectively, 20). Each antenna 20 is connected to a separate port or channel on the reader 24. The separate ports/channels correspond to separate transceivers 26a, 26b, 26c, 26d (collectively, 26). The transceivers 26 generate RF-level excitation signals for driving their respective antennas 20 to propagate RF signals and they receive incoming RF signals induced in their respective antennas 20.

The reader 24 includes a controller 30 configured to control the transceivers 26. The controller 30 may send instructions or other messages to the transceivers 26 to control their operation in accordance with a predefined ETC communication protocol or scanning pattern. The controller 30 may input data signals to the transceivers 26, which the transceivers 26 may modulate and transmit as RF signals via their respective antennas 20. The controller 30 may also receive demodulated and/or decoded signals from the transceivers 26.

The controller 30 may include a transaction manager 36 configured to implement the ETC transaction protocol. In some embodiments this may include reading the transponder information obtained from the transponder, determining a toll transaction amount based, for example, on the last toll plaza identity contained in the transponder information, interfacing with an external payment processor 40 to debit an account associated with the transponder in the amount of the toll transaction, and sending confirmation of payment to the transponder. Other functions or operations may be performed by the transaction manager in the course of conducting an ETC transaction, as will be appreciated by those ordinarily skilled in the art.

The controller 30 may also include a lane assignment module 34 for tracking transponders and making a location decision with regard to each transponder, as will be described further below. The lane assignment module 34 may communicate lane assignment information to an external enforcement system 38, which is configured to take enforcement action in connection with vehicles traversing the zone without a valid ETC transaction. The enforcement system 38 may rely, at least in part, upon the lane assignment information from the lane assignment module 34 in determining where to direct enforcement activity. It may also receive data from the transaction manager 36 indicating which transponders have successfully completed an ETC transaction.

The controller 30 may be implemented through a combination of hardware and software. For example, in one embodiment, the controller 30 may be realized using a microprocessor and associated memory devices containing a stored program to configure the microprocessor to implement the steps associated with a particular ETC communication and transaction protocol. In another embodiment, the controller 30 may be implemented using a suitably programmed microcontroller or general purpose computing device. In yet another embodiment, the controller 30 may be implemented using one or more application-specific integrated circuits (ASICs). The range of options will be well understood by those skilled in the art. The suitable programming of such devices to realize a given ETC communications protocol will also be within the skill of those ordinarily versed in the art.

The design and operation of a suitable reader, including the design of suitable transceivers, will be within the skill of a person of ordinary skill in the art.

It will be appreciated that the reader 24 cycles through its channels to scan across the antennas 20 using a time multiplexing. In embodiments in which each antenna 20 is dedicated to a lane, the scan is across adjacent lanes. A given toll location may include more than one reader 24 if the reader 24 has an insufficient number of channels/antennas 20 to span the full width of the roadway. In such a case the spatial separation between the same channels on two readers may be sufficient to prevent interference. In other words, each of the two readers may scan their respective first channel at the same time, their second channels at the same, etc. For simplicity, in the embodiments described herein a single reader is described.

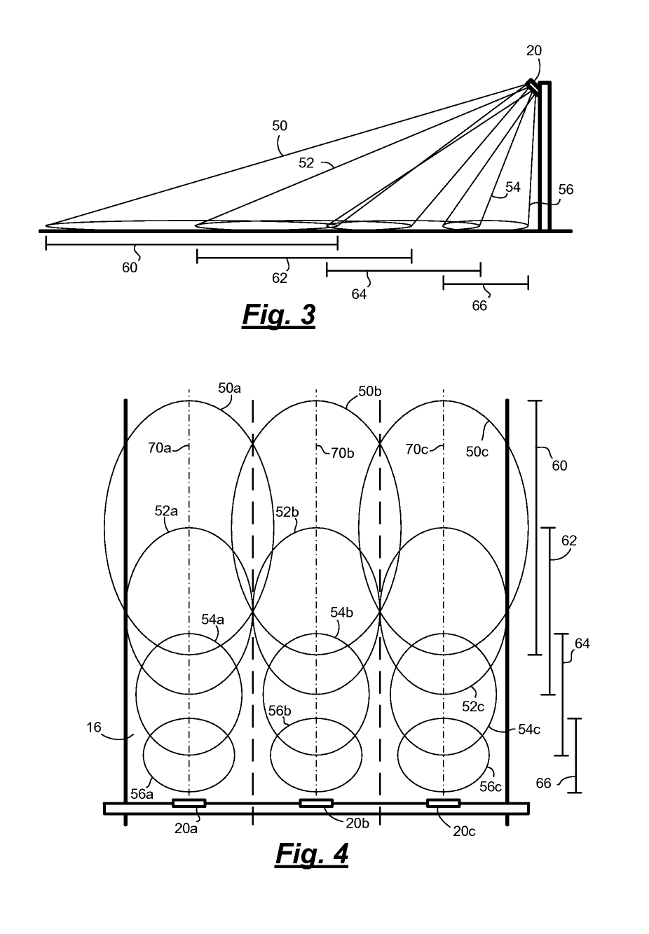

Reference is now also made to FIGS. 3 and 4. FIG. 3 diagrammatically shows a side view of the radiation pattern of one of the antennas 20. FIG. 4 diagrammatically shows a plan view of the radiation pattern of the antennas 20 in one embodiment.

Each of the antennas 20 is an array antenna configured to have a directive radiation pattern. In particular, each antenna 20 is configured to have a sequence of selectable beams. Each beam may be considered to have a center ray marking the center of the beam. The center rays of all the beams for one of the antennas 20 lie substantially within a vertical plane between the antenna 20 and the roadway 16. Each of the vertical planes is substantially parallel to the direction of travel in the roadway and, thus, spaced apart and substantially parallel to each other. In one embodiment, the vertical planes are substantially centered within the roadway.

The vertical planes defined by the center rays of the beams of each antenna 20 intersect the roadway 16 along a beam path 70 (individually shows as 70a, 70b, 70c). In another sense, the beam path 70 may be defined as a path in the roadway 16 intersected by the center rays of each of the beams. Note that the terminology “beam path” does not necessarily imply that the beams are scanned in sequence along the path. The scanning pattern may, in some embodiments, follow the beam path from one end of the path to the other end of the path in sequence, but not necessarily. The beam paths 70 are substantially parallel to the direction of travel in the roadway 16. In one embodiment, the beam paths 70 are substantially centered within their respective laneways.

The antennas 20 illustrated in FIGS. 3 and 4 feature four beams each; however, other embodiments may have more or fewer beams. The illustration in FIG. 3 shows a side view of a projection of the beams onto a vertical plane parallel to the direction of travel in the roadway 16. FIG. 4 shows a plan view of a projection of the beams onto a horizontal plane parallel to the surface of the roadway 16. It will be understood that the projections shown are the ½ strength or 3 dB lines of the beams. It will also be appreciated that, in operation, only one of the beams of an antenna is enabled at any one time.

It will be noted that the antennas 20 are mounted to a gantry or other support above the roadway 16 and are positioned and configured to direct a first beam 50 (individually 50a, 50b, 50c) upstream in the direction of oncoming traffic but substantially below the horizon. Accordingly, each of the first beams 50 results in a wide coverage area 60 upstream of the antennas 20. Each of the first beams 50 is likely to have significant overlap with each other and may result in the wide coverage area 60 containing more than one vehicle-mounted transponder at any given time.

Each of the antennas 20 are further positioned and configured to direct a last beam 56 (individually 56a, 56b, 56c) substantially downwards into the roadway 16 from the antenna's position above the roadway 16. Accordingly, the last beams 56 each define a relatively narrow coverage area 66. In some embodiments, the antennas 20 may be selected and configured to have a radiation pattern such that the last beams 56 create the relatively narrow coverage area 66 having a length in the direction of the travel that will have only one vehicle present at a time. For example, the length of the narrow coverage area 66 may, in some embodiments, be ten feet or less.

Between the first beams 50 and the last beams 56 in the scan sequence, each antenna 20 has one or more intermediate beams. In this example, each antenna 20 has a second beam 52 (individually 52a, 52b, 52c) and a third beam 54 (individually 54a, 54b, 54c), although it will be appreciated that other embodiments may have more or fewer intermediate beams. The second beams 52 define second coverage areas 62 and the third beams 54 define third coverage areas 64. It will be appreciated that in one embodiment, the antennas 20 are configured and positioned such that the coverage areas 60, 62, 64, 66, defined by the beams 50, 52, 54, 56 get progressively more focused from the wide coverage area 60 to the narrow coverage area 66, as the beams are directed in order of decreasing elevation. This results in the focusing of the coverage area 60-66 by virtue of the fact the distance the beam travels from the antenna 20 to the roadway 16 decreases from the first beam 50 to the last beam 56, meaning there is less opportunity for beam pattern divergence as the beam travel distance is shortened.

It will be appreciated that the terminology “first beam”, “second beam”, “third beam” and “last beam” is not intended to imply a scanning sequence. Instead, the terminology refers to the order in which a vehicle traveling in the roadway 16 will encounter the beams.

The progression from a widebeam to narrowbeam pattern in the direction of travel is advantageous in that it allows the ETC system 10 (FIG. 1) to begin TDMA processing with the first detection of a transponder-equipped vehicle entering the wide coverage area 60. TDMA processing tends to require a significant amount of time to initiate and complete a transaction. Accordingly, early detection of incoming transponders is required to initiate the processing. In existing ETC systems, this was typically accomplished by having a separate wide area TDMA coverage zone for detecting incoming vehicles and beginning the process. A second lane-based coverage zone was then established using separate antennas to complete the ETC transactions. Yet a third set of antennas was used for detecting transponder locations coming into the second lane-based coverage zone for lane assignment and enforcement purposes. An example of such a system is described in U.S. Pat. No. 6,661,352, to Tiernay et al. In the present example embodiment, the single set of antennas 20 is configured to realize all these functions.

The antennas 20 are able to track the progress of the transponder-equipped vehicle through the coverage areas 60, 62, 64, 66, with increasing certainty as to in which area the vehicle is located. Initially, more than one of the antennas 20 will be able to communicate with the transponder due to the overlapping coverage in the wide coverage area 60. One of the antennas 20 may be selected for conducting TDMA communications with the transponder in the wide coverage area 60 based on signal strength measurements or other such factors, as with existing TDMA systems; however, the vehicle position cannot be determined with great accuracy at this stage due to the inaccuracy of signal strength measurements because of multipath and other such issues. As the transponder travels into more focused coverage areas 62, 64, 66, the ETC system 10 is able to more accurately determine its position within the roadway 16. By the time the transponder is in one of the narrow coverage areas 66, the ETC system 10 is able to make a definitive lane assignment with regard to the transponder. Within the narrow coverage area 66 the lane assignment made by the lane assignment module 34 (FIG. 2) may be determined using any of a number of techniques including received signal strength indicators (RSSI), voting algorithms, etc.

It will be appreciated that the ETC system 10 allows the ‘tracking’ of a vehicle into the toll area and the transaction communication associated with an ETC transaction using a single set of antennas, rather than a multiplicity of antennas for performing different functions.

Moreover, it will be noted that each of the antennas 20, as best seen in FIG. 4, is dedicated to an individual lane within the roadway. Accordingly, the narrow coverage zone 66 for each antenna is confined to an individual lane and to completing ETC transactions for transponders traveling in that lane. In some embodiments the ETC system may include “midpoint” antennas disposed on the gantry or supporting structure between laneways to provide overlapping coverage. The midpoint antennas may assist in the lane assignment decision or in tracking vehicles changing lanes.

It will be appreciated that the use of antenna arrays 20 having multiple beams will put some pressure on the scan speed of the ETC system 10. The reader in an existing ETC system already sequentially scans through adjacent channels/antennas to complete a scan of the roadway. With each antenna having multiple beams, the scan time becomes that much longer.

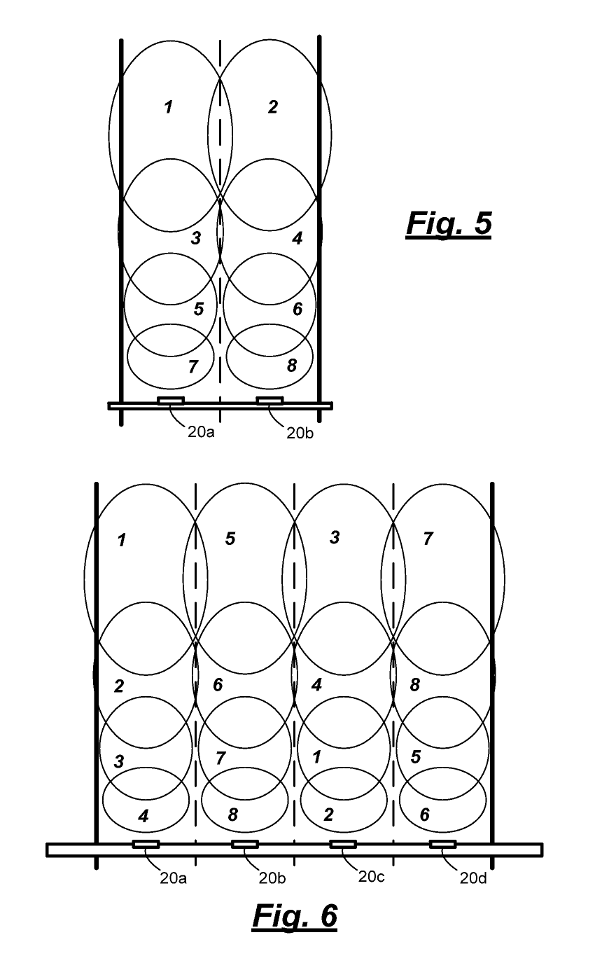

By way of an example, the ETC system 10 described above may be used in an open road installation employing a TDMA ETC protocol. In one example embodiment, the TDMA protocol may specify a frame duration of approximately 10 ms. In this example, as illustrated in FIG. 5, the open road includes two lanes each having one array antenna 20. If each array antenna 20 has four beams, then the reader 24 may first scan the wide coverage area 60a of the first antenna 20a, then the wide coverage area 60b of the second antenna 20b, then intermediate coverage area 62a of the first antenna 20a, etc. in the sequence numerically indicated in FIG. 5. This results in eight separate time-multiplexed frames of duration 10 ms, for an overall scan time of 0.08 seconds. If a vehicle travels at 100 km/h, the vehicle would traverse 2.2 meters, or over seven feet, in the course of the scan. With open road installations, this may restrict the number of channels that may be used by a reader 24.

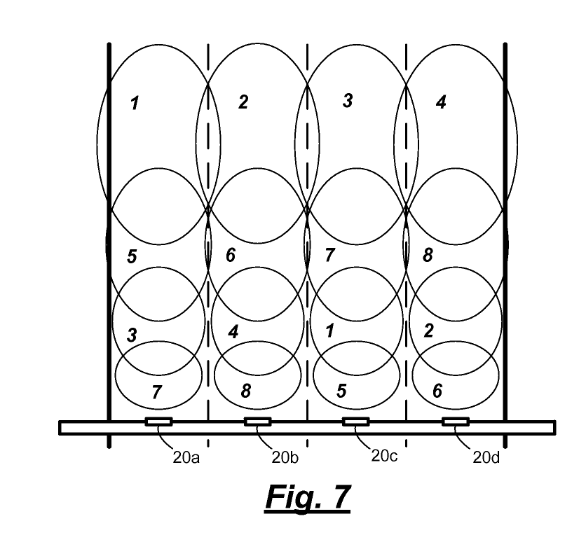

In order to facilitate contemporaneous scanning of antennas with limited spatial separation, the scan pattern may be established so as to ensure that wide area coverage zones 60 or second coverage zones 62 for two antennas separated by only one or two lanes are not scanned at the same time. Reference is now made to FIG. 6, which diagrammatically shows an example of a scanning pattern for a four antenna ETC system 10.

In FIG. 6, the first antenna 20a is scanned at the same time as the third antenna 20c; however, whereas the first antenna 20a is configured to scan its wide area coverage zone 60a first, the third antenna 20c begins the scan sequence with a scan of its third coverage zone 64c, thereby reducing the likelihood of interference as compared to mutual scanning of the wide area coverage zones 60a, 60c. Within FIG. 6, numerals 1 to 8 indicate the scanning pattern sequence. It will be noted that none of the wide area coverage zones 60 or second coverage zones 62 are scanned at the same time. An alternative scan pattern that achieves the same staggering of scans is illustrated in FIG. 7.

It will be appreciated that some of the scan time concerns outlined above are mitigated in the case of closed-road or gated toll plazas due to the reduced travel speed of the vehicles.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. An electronic toll collection system for conducting electronic toll collection for a multilane roadway having a direction of travel, the system comprising:
a first phased array antenna disposed above a first laneway in the roadway and positioned and configured to have a first plurality of beams, each beam having a beam center ray substantially within a first vertical plane parallel with the direction of travel;
a second phased array antenna disposed above a second laneway adjacent the first laneway in the roadway and positioned and configured to have a second plurality of beams, each beam having a beam center ray substantially within a second vertical plane parallel with the direction of travel; and
a reader including a first transceiver for exciting and controlling the first phased array antenna and for receiving incoming signals from the first phased array antenna, a second transceiver for exciting and controlling the second phased array antenna and for receiving incoming signals from the second phased array antenna, and a controller for controlling the transceivers, wherein the controller is configured to conduct electronic toll communications with a transponder within the roadway through the antennas, and wherein the controller is configured to determine whether said transponder is located in said first laneway or said second laneway based on said incoming signals from the first and second phased array antennas.

2. The system claimed in claim 1, wherein the first phased array antenna and the second phased array antenna are both configured to scan their respective plurality of beams in the direction of travel.

3. The system claimed in claim 1, wherein said first plurality of beams and said second plurality of beams each include an initial beam defining a wide coverage area and a last beam defining a narrow coverage area, and wherein said narrow coverage areas are downstream from said wide coverage areas with respect to the direction of travel.

4. The system claimed in claim 3, wherein said narrow coverage areas are confined to their respective laneways.

5. The system claimed in claim 3, wherein said antennas are configured to direct said initial beams at a predetermined declination below horizontal and said last beams at a larger declination below horizontal, and wherein other of said plurality of beams are directed at declinations below horizontal between said predetermined declination and said larger declination.

6. The system claimed in claim 1, wherein each beam of said first and second pluralities of beams defines a coverage area, and wherein said reader is configured to time-multiplex said beams.

7. The system claimed in claim 1, further including a third phased array antenna disposed above a third laneway adjacent the second laneway in the roadway and positioned and configured to have a third plurality of beams, each beam having a beam center ray substantially within a third vertical plane parallel with the direction of travel, and wherein said reader further includes a third transceiver for receiving incoming signals from the third phased array antenna.

8. The system claimed in claim 1, wherein said reader is configured to implement a TMDA ETC communication protocol.

9. An electronic toll collection system for conducting electronic toll collection for a multilane roadway having a direction of travel, the system comprising:
a first phased array antenna disposed above a first laneway in the roadway and positioned and configured to have a first plurality of beams defining a first series of coverage areas substantially centered along a first beam path parallel to said direction of travel;
a second phased array antenna disposed above a second laneway adjacent the first laneway in the roadway and positioned and configured to have a second plurality of beams defining a second series of coverage areas substantially centered along a second beam path parallel to said direction of travel; and
a reader including a first transceiver for exciting and controlling the first phased array antenna and for receiving incoming signals from the first phased array antenna, a second transceiver for exciting and controlling the second phased array antenna and for receiving incoming signals from the second phased array antenna, and a controller for controlling the transceivers, wherein the controller is configured to conduct electronic toll communications with a transponder within the roadway through the antennas, and wherein the controller is configured to determine whether said transponder is located in said first laneway or said second laneway based on said incoming signals from the first and second phased array antennas.

10. The system claimed in claim 9, wherein said first and second beam paths are substantially centered within said first and second laneways, respectively.

11. The system claimed in claim 9, wherein said first plurality of beams and said second plurality of beams each include an initial beam defining a wide coverage area and a last beam defining a narrow coverage area, and wherein said narrow coverage areas are downstream from said wide coverage areas with respect to the direction of travel.

12. The system claimed in claim 11, wherein said narrow coverage areas are confined to their respective laneways.

13. The system claimed in claim 11, wherein said antennas are configured to direct said initial beams at a predetermined declination below horizontal and said last beams at a larger declination below horizontal, and wherein other of said plurality of beams are directed at declinations below horizontal between said predetermined declination and said larger declination.

14. The system claimed in claim 9, wherein said reader is configured to time-multiplex said beams.

15. The system claimed in claim 9, further including a third phased array antenna disposed above a third laneway adjacent the second laneway in the roadway and positioned and configured to have a third plurality of beams defining a third series of coverage areas substantially centered along a third beam path parallel with the direction of travel, and wherein said reader further includes a third transceiver for receiving incoming signals from the third phased array antenna.

16. The system claimed in claim 1, wherein said reader is configured to implement a TMDA ETC communication protocol.
